(19) United States
(12) Patent Application Publication
(10) Pub. No.: US 2020/0150613 A1
(43) Pub. Date: May 14, 2020

(54) Method and device for operating and controlling a machine installation by means of a graphical development interface and generation of a field bus configuration

(71) Applicant: Bachmann GmbH, Feldkirch (AT)

(72) Inventors: Ambros Morscher, Bludenz (AT); Mathias Rieder, Hohenems (AT); Markus Maghoerndl, Hoerbranz (AT); Martin Schreiber, Feldkirch (AT); Christian Mathis, Lauterach (AT)

(21) Appl. No.: 16/683,423

(22) Filed: Nov. 14, 2019

(30) Foreign Application Priority Data
Nov. 14, 2018 (DE) 10 2018 128 502.7

(51) Int. Cl. G05B 19/042

(52) U.S. Cl. CPC G05B 19/0426; G05B 2219/23258; G05B 2219/25014

(57) ABSTRACT

A method for operating and controlling a machine installation by means of a graphical development environment (1), with which a controller on the machine side having programmable hardware modules (13, 14) situated there is graphically displayed, and via user-side inputs a programming sequence (24) is created in the development environment (1) and is supplied to the hardware modules (13, 14). According to the invention, an embedded web server (2) and an embedded browser (4) that communicates with same are integrated into the development environment (1), and the programming sequence (24) created in the development environment (1) is supplied to a field bus master (8), which supplies the programming sequence (24) via a field bus (10) to the station head (12) of a hardware station (11) in which the hardware modules (13, 14) which are programmable with the programming sequence (24) are situated and communicate with the station head (12).

The invention relates to a method and a device according to the preamble of claim 1.

In the programming of certain hardware, in particular hardware for machine controllers, it is important for the hardware to be programmable using a graphical user interface in the most simple and reproducible manner possible.

Such hardware is made up of numerous control components of a machine controller, such as that of a wind turbine or the like, and may include, for example, programmable inputs and outputs, actuating modules, temperature modules, and the like.

A program generator having a graphical development interface and automatic code generation has become known from DE 10 2004 043 788 A1 The program generator disclosed therein provides a graphical development interface, with individual graphical development modules being drawn on a user interface to create a certain executable program. The program is specified as a model having individual modules.

The model is made up of individual graphical symbols that are arranged on the user interface in such a way that an executable program having a certain sequence structure results.

For example, another method and device according to the preamble are known which relate to the same subject matter as DE 10 2007 014 271 A1 by the present applicant, in which a graphical development interface with automatic code generation is described, and a program generator is present via which individual graphical development modules may be drawn on a user interface to create a certain executable program.

The subject matter of the cited publication relates to the provision of a user-side control terminal in order to refine a configurator having Java visualization and to obtain an improved configurator.

In the cited publication, a graphical interface composed essentially of a machine model created on an initially blank page is present on a screen of a given input device, it being possible to create an executable controller by drawing individual components of one or more palettes on the machine model (initially present as a blank page), and to associate machine-based process parameters, for example status monitoring points, alarm points, temperature information points, and other control parameters, with the hardware components.

However, this system reached its technical limits due to the lack of an option for adding individual components on the user side, owing to the fact that this involved a closed system in which external influence using the user's own additional modules was not possible.

Another disadvantage was the lack of compatibility with external applications, such as mobile telephone applications and the like.

In other respects, the use of a Java-based interface no longer corresponded to the most recent state of the art, and therefore updating the module and maintaining the development environment was resource-intensive.

The object of the invention, therefore, proceeding from DE 10 2007 014 271 A1, is to refine a method and a device for operating and controlling a machine installation in such a way that a graphical configuration and development environment can be created which are suitable for programming the hardware components of a hardware station in an operationally secure manner and with greater ease of operation.

The invention is also intended to operate with smaller data volumes, and thus also more quickly, and with the option for adding WWW applications, for example web components, outside the development environment, which has not been possible in the past.

One disadvantage in particular with the subject matter of DE 10 2007 014 271 A is that it involved a dual development environment, namely, a first graphical interface representing a so-called solution center (SC) that contained a graphically based configurator which ultimately generated an automatic code with which a user interface was programmed, and this user interface then took over the programming of the hardware components.

Thus, this involved relatively laborious, time-consuming, and also vulnerable programming, which the invention aims to avoid.

To achieve the stated object, the preferred method according to the invention is characterized in that an embedded web server and an embedded browser that communicates with same via an HTML interface are integrated into a graphical configurator and development environment (SC), and the programming sequence created in the configurator and development environment is suppliable via an Ethernet connection to the configuration module which is situated in a field bus master, and which supplies the programming sequence via a field bus to the station head of a hardware station in which the hardware components which are programmable with the programming sequence are situated and communicate with the station head.

As a preferred exemplary embodiment, the development environment is preferably made up of Eclipse configurator components into which according to the invention an embedded web server and an embedded browser are now integrated.

A web server is a server that transmits documents to clients [via] a web browser, for example. The computer with web server software or only the web server software itself is referred to as a web server. Web servers are used locally, in company networks, and for the most part as a WWW service on the Internet. Documents may thus be provided locally, internally within a company, and worldwide for the needed purpose.

The primary task of a web server is to deliver static files, for example unchangeable HTML or image files, or dynamically created files, for example web pages, whose content is always created individually according to the profile of a logged-in user.

For a complete website, generally the HTML page, including linked design descriptions (CSS), and image files (JPG, PNG, GIF, SVG) are each transmitted as individual files. For each required file, the web browser must send a separate request to the web server; i.e., several hundred requests and server responses are needed in order to display a complex website. A web server is able to deliver the content of a website simultaneously to many different computers. The processing speed for user requests depends to a great extent on the complexity of the web content; for example, dynamic web content requires more resources than static web content.

Standardized transmission protocols (HTTP, HTTPS) and network protocols such as IP and TCP are used as transmission methods, typically via port 80 (HTTP) and port 443 (HTTPS). HTTP is the most commonly used protocol.

Web browsers are specialized computer programs for displaying websites on the World Wide Web, or documents and data in general. In addition to HTML pages, web browsers can display various other types of documents such as images and PDF documents. Web browsers represent the user interface for web applications.

Eclipse is an open source programming tool for software development, and forms the basis of the present configurator and development environment.

At the present time, the development environment made up of native Eclipse components is implemented in the Java and XTend programming languages, and the native Eclipse components are thus seamlessly integrated into the configurator and development environment, also referred to below as a solution center (SC).

The Eclipse UI framework provides a browser component (SWT Browser widget) for displaying web content (HTML, CSS, This mechanism is used by Eclipse's auxiliary system. An integrated web server provides assistance in the form of static HTML pages that are displayed in the Eclipse browser component.

The use of current web technologies offers advantages in particular for hardware configurators, since the content may be more comprehensive and more interactive. This is particularly valuable for more complicated hardware modules with complex dependencies between configuration values and graphical elements used in the configuration.

Modern web UI frameworks are easier to manage and are more current than the Eclipse code base, which is somewhat out of date. This results in advantages in implementing possible features such as animations in the configuration process, as well as efficient development to the most current state of the art.

Besides the mere display of static web content, a much stronger link between the web configurators and the Eclipse mechanisms is necessary. In particular, the following Eclipse functionalities must be usable in web configurators for seamless and user-friendly integration:
Change recognition (dirty state editor action): When changes are made in the configurator via the browser, the editor should report this as a flagged change. In Eclipse, this is provided by a * symbol in the label of the editor. From a technical standpoint, it must thus be possible to communicate browser inputs to the SC in order to manage the editor state.
Undo/redo action: Via the Eclipse undo/redo stack it should be possible to restore or repeat changes made in the browser. Eclipse provides an edit menu and shortcuts for this purpose.
Drag&Drop support: It should be possible to transfer the SC content into the configurator by D&D. This may be meaningful for setting configuration values.
Life cycle of UI components: When a new module is created, the editor should be automatically opened, and the web application for the configuration should be started.
Incorporation of native SC widgets into web configurators: For some actions it is meaningful to use native solution center (SC) widgets. One use for this purpose would be an SC-specific selection dialogue in order to select files or other elements.

The web configurator that is integrated into the solution center also represents the basis for a strictly web-based configuration. In the approach according to the invention, a typical web browser communicates with a web server on a controller in order to implement the configuration (hardware programming) of the controller with its hardware and software modules.

The implementation described here is an intermediate step for a strictly web-based configuration mechanism.

The following section presents the solution architecture, which allows the use of web technologies that are integrated into the solution center.

As a result, in the present invention a Java-implemented configuration is dispensed with, and instead, it is now possible for the first time to use certain web technologies, which thus far has not been known in the older prior art.

The web server is integrated into the solution center (SC), which preferably provides a REST API.

In the term “REST API,” “REST” (less often referred to as “ReST”) stands for “representational state transfer,” and refers to a programming paradigm for distributed systems, in particular web services. REST is an abstraction of the structure and the characteristics of the World Wide Web. The aim of REST is to create an architectural style that better represents the requirements of the modern web. REST differs from other architectural styles primarily in the requirement for a uniform interface.

The main focus of REST is machine-to-machine communication. REST represents a simple alternative to similar methods such as SOAP and WSDL and the related RPC method. Unlike many related architectures, REST does not encode method information into the URI, since the URI indicates the location and name of the resource, but not the functionality that the web service provides to the resource. The advantage of REST is that most of the infrastructure required for REST (for example, web and application servers, HTTP-capable clients, HTML and XML parsers, security mechanisms) is already present in the WWW, and many web services are REST-conforming per se. A resource may be represented via various types of media, also referred to as representation of the resource.

This REST API allows communication between the web front end and the solution center (SC). The web server is available as an SC plug-in, and can thus access all functions in the SC. The “Controller Communication API” of the solution center is used in particular for communication and writing of the configuration. However, the complete user interface may also be accessed, which allows dialogues or other UI components to be controlled. The REST API records Java-based end points on predefined URLS. These end points are used as the interface for SC functionality.

The Eclipse SWT Browser widget is used as the browser component and is integrated into an SC editor. The data exchange between the browser and the web server takes place via JSON.

JavaScript Object Notation (JSON) is a compact data format in an easily readable text format for the purpose of data exchange between applications. Each valid JSON document should be a valid JavaScript, and may be interpreted for each evaluation. However, due to small deviations in the quantity of allowed Unicode characters, it is possible to create JSON objects that are not accepted by a nonconforming JavaScript interpreter. Aside from that, however, JSON is independent of the programming language. Parsers exist in practically all widely used languages.

The back end interprets the data and carries out the corresponding SC functionality. The communication is based on HTTP commands (GET, PUT, PATCH, . . . ), so that information can be exchanged in both directions.

In 2001, IBM developed SWT for the Eclipse development environment, and continuously updates it. In contrast to Swing, SWT uses the native graphical elements of the operating system, such as AWT from Sun, and thus allows creation of programs that have an appearance comparable to “native” programs.

In SWT, native widgets are covered by thin wrappers instead of retrieving portions of the functionality in native peer classes. Based on the use of these resources, the SWT elements are referred to as “heavyweight,” in contrast to the “lightweight” components of Swing technology, which generate all graphical elements themselves.

SWT is used in a number of applications, such as Eclipse itself, Vuze, and RSSOwl.

The application of a new hardware module takes place in the development environment. When the hardware module from the SC is opened, the web server is started and provides the configurator as a web application. The SWT browser widget opens the configurator via a module-specific URL, and retrieves the configuration data via the REST API.

The term “solution center” may be understood as a development environment characterized by an embedded web server, as well as an embedded browser that communicates solely with this embedded web server, being present in this development environment.

For this reason, in the development environment there is an interface, for example the http://127.0.0.1 interface, between the embedded web server, and bidirectional data exchange between the embedded web server and the embedded browser takes place via this interface.

Thus, there is the advantage that it is now possible for the first time for various components to be written into the development environment, in particular by the manufacturer; these development components may be based, for example, on Java script or cascading style sheets (css) and HTML5 applications.

The scope and range of application of such a development environment are thus significantly expanded compared to the prior art, since the prior art at that time considered only a Java-based programming environment.

According to another preferred feature of the invention, it is provided that the programming of the field bus takes place, and the field bus in turn programs the corresponding hardware components.

A field bus is a bus system that connects field devices such as sensors and actuators in a facility for communication with an automation device. When multiple communication participants transmit their messages over the same line, it must be determined who is communicating the message (identifier), and what is communicated (measured value, command) and when (initiative). There are standard protocols for this purpose.

A uniform programming language for the field bus is thus provided due to the fact that the field bus is a standardized application, which therefore programs the hardware components to be individually programmed, using standardized data.

Since there are different field bus applications which may possibly also be programmed differently, another advantage of the invention is that the configurator according to the invention now also provides the data for various field bus applications without different programming having to take place for each of the various field bus applications.

The field bus replaces the parallel cable bundles with a single bus cable, and connects all levels, from the field level to the command level. Regardless of the type of automation device, for example memory-programmable controllers (SPS) from different manufacturers or PC-based controllers, the transmission medium of the field bus links the components in the field and makes them available for programming.

A bus interface card having a field bus master is used instead of multiple cards. This reduces the space requirements in the control cabinet.

The advantage of this measure is that the hardware components are generally present with the customer, and the programming takes place via a field bus on the customer side; it is entirely possible for different customers to have different field bus configurations.

Thus, the value of the invention lies in the fact that with the novel development environment, it is now possible to easily influence different field bus configurations in each case on the customer side, and to use different field bus applications for programming hardware components.

Thus, this involves a field bus-centered system of the hardware configuration, which is advantageous in that the web server may also be operated on the customer-side CPU, i.e., on the customer-side controller, at a later time. It is thus possible for the web server that is present in the development environment to also run on the controller on the customer side, which has the advantage that the customer can configure the modules using portable devices.

For this purpose, there is no longer a need for a costly notebook and the associated computer control; instead, the programming may easily take place via an Ethernet interface, for example via a mobile telephone.

When a mobile telephone is used, the mobile telephone must have a WLAN connection in order to transmit data.

This results in the advantage that the hardware components on the customer side, which possibly do not have to be reprogrammed, are particularly easily accessible for service, which previously was not known.

Thus, during start-up the data and the functional capability of the pre-programmed hardware modules may be monitored very well, without the need for complicated retranslation or costly controls.

A further advantage is that only a browser that is currently available on the market is needed, and the browser responds with an appropriate URL address in order to use all options of this browser, without having to use specially programmed software.

The customer-side programming of the hardware modules may thus take place using standard applications.

A sequence for storing a configuration value in the development environment is schematically described in the following depictions, and is also explained in greater detail below with respect to the drawings.

1. The user inputs a new value into the development environment.

2. The web front end sends an HTTP PATCH request having the URL “/api/config/devices/DEVICE_NAME/modules/1001/slots/1/configobjects/0x001.” The patch transmits the changed value of the configuration as a payload. The back end retrieves the corresponding API end point “Update Value.”

3. The end point communicates to the editor via a data connection that values have changed so that the editor can update its “dirty state.”

4. The end point writes, via the “Controller Communication API,” the configuration value onto the controller that is formed from hardware modules.

This sequence may be used for most situations. Communication with the controller and with the user interface of the development environment SC is made possible, which gives the user the feel of native integration.

Undo/redo requires bidirectional communication. This is made possible by use of the web socket protocol, which may also be initiated by the server based on communication to the web application.

Thus, if an undo/redo action is triggered via the edit menu in the SC, the web front end receives the information that something has changed in the SC.

The subject matter of the present invention results not only from the subject matter of the individual patent claims, but also from the combination of the individual patent claims with one another.

All information and features disclosed in the application documents, including the abstract, in particular the spatial design illustrated in the drawings, may be claimed as essential to the invention, provided that, alone or in combination, they are novel with respect to the prior art. Use of the terms “essential” or “according to the invention” or “essential to the invention” is subjective, and does not imply that the features thus designated must necessarily be a component or one or more patent claims.

The invention is explained in greater detail below with reference to drawings that illustrate several implementation approaches. In this regard, further features and advantages of the invention that are essential to the invention emerge from the drawings and their description.

In the drawings:

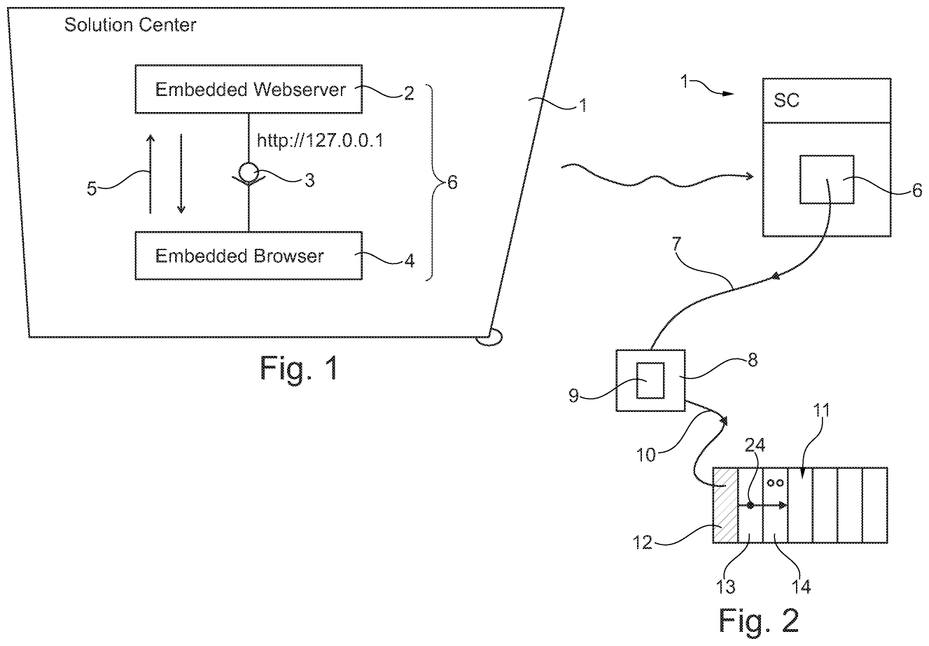

FIG. 1: shows a simplified block diagram of a development environment (solution center)

FIG. 2: shows an illustration of the programming of hardware components with the aid of the development environment illustrated in FIG. 1

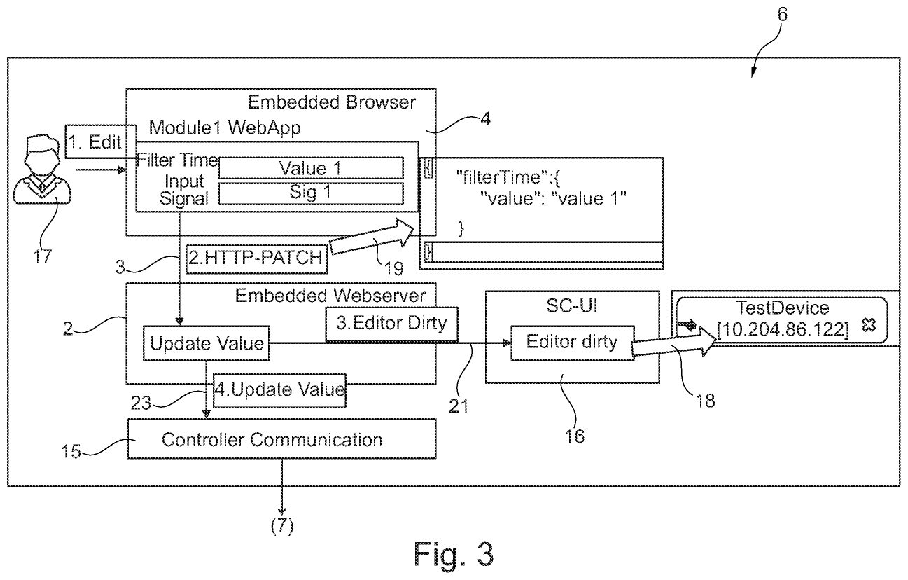

FIG. 3: shows a schematic illustration of a configurator that is integrated into the development environment

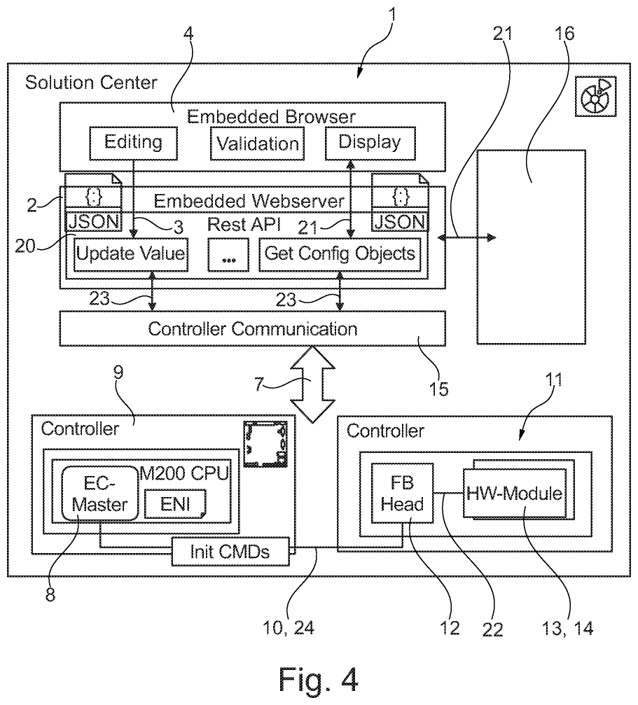

FIG. 4: shows an illustration that is modified from FIG. 3, with the connection to individual hardware modules of a station head of a controller

FIG. 1 shows in general a development environment 1 which is preferably programmed in Eclipse Java and which provides the user with a graphical display for compiling the user's configuration.

It is preferred that according to the invention an embedded web server 2 is implemented in this graphical development environment 1. The embedded web server provides an HTTP interface on a local port of the development environment 1. The embedded web server 2 preferably has no connection with external components, and instead runs as a local application which thus operates in a particularly operationally secure manner without disturbances.

The embedded web server 2 generates bidirectional data traffic between the embedded web server 2 and an embedded browser 4 connected thereto via a REST-based, HTTP-based interface 3, corresponding to the illustrated arrows 5.

The embedded browser 4 obtains from the embedded web server 2 the information concerning the respectively plugged-in hardware modules 13, 14 in the hardware station 11, and provides a graphical user interface to allow the option for programming and thus, generation or a change of a configuration of the hardware modules 13, 14.

The embedded browser checks in particular that only valid configurations are implemented.

The embedded web server 2 and the embedded browser 4 together thus form a configurator 6, which is integrated into the above-mentioned development environment 1.

Further particulars of the development interface together with code generation for a field bus 10 are apparent in FIG. 2.

The same development environment 1 is schematically illustrated in FIG. 2, which as a further feature, at the output of the development environment 1 has an Ethernet connection 7 that acts on a field bus master 8.

A configuration module 9 which according to the invention is programmable by the development environment 1, namely, the configurator 6, is present in the field bus master.

A common type of field bus 10, which may be designed, for example, as a can bus, an Ethercat bus, a Profinet bus, or as a similar field bus, is connected to the output of the field bus master 8.

It is important that various bus configurations are possible for the field bus 10, and that the development environment 1 together with the configurator 6 controls all known types of field buses.

The field bus 10 acts on a station head 12 on the hardware side in the hardware station 11, which forms the head for a series of hardware modules 13, 14 that are connected to one another via individual bus connections.

The entire hardware portion is referred to as a hardware station 11, and the individual hardware modules may be, for example, input and output modules that are situated on individual circuit boards and plugged in a control cabinet, and that are in each case individually programmable via the field bus 10 and the station head 12.

Instead of the input and output modules, other modules may be used, such as alarm modules, limit value modules, temperature and moisture modules, and the like.

It is important for the hardware station 11 to contain all hardware components for a facility, such as those necessary for wind turbine controllers or machine controllers, for example.

In particular, power plant controllers may also be designed in the sense of the hardware station 11 described above.

The invention thus results in the advantage that with a development environment 1 having a relatively simple design and a configurator 6, integrated therein, that is made up of modules, namely, an embedded web server 2 that operates only locally in the development environment 1 and an embedded browser 4 connected thereto via an interface, an easily operated development environment 1 is created that may be used for various applications.

It is preferred that the development environment 1 operates with Eclipse components, and a development environment 1 is thus specified which according to the technical teaching of the invention is now refined by a particular configurator 6.

FIG. 3 illustrates such a configurator 6 in a schematic layout in which it is apparent that the embedded browser 4 cooperates with the embedded web server 2 via the above-mentioned interface 3.

In the embedded browser, one particular development module is referred to as “Module 1” with which certain values and certain input and output signals (Sig1) are associated.

The specified values are now input via the bidirectional interface 3 to the embedded web server 2, which thus renews its already stored values, and outputs a message when it determines that the values generated by the embedded browser 4 are new. A user interface 16 in which a graphical message 18 is generated is then addressed via the data path 21, so that the user, based on his/her user input 17, is able to recognize that he/has initiated a new configuration.

The programming of the bidirectional interface 3 is illustrated by the information arrow 19 by way of example, that shows which data traffic is taking place via the programmable interface 3.

Provided at the output of the interface 15, which is directly connected to the embedded web server 2 via the signal path 23, is an Ethernet connection 7 which according to FIG. 2 acts on the field bus master 8 and a configuration module 9 indicated at that location.

Further particulars of the connection of the development environment to the hardware components are apparent from FIG. 4.

In a further description of the function of the embedded browser 4, it is apparent from FIG. 4 that this browser has an editing function, a verification function (Validation), and a display function (Display) for the user for displaying the input values.

Reference numeral 24 denotes the [programming sequence] according to the REST API, which is integrated into the embedded web server 2 and which determines the renewal or change of input values and outputs a certain message via the path 21 when a change in the values is determined.

A graphical output on the user interface 16 also takes place via the data path 21.

It is preferred for a configuration module 9 in the field bus master 8 to now be addressed via the Ethernet connection 7, and the configuration module thus provides a control sequence that is used for programming the hardware components in the hardware station 11. This control information or programming information is supplied to the station head 12 of the hardware station 11, which uses this information to generate the corresponding configuration signals or programming signals on the internal bus 22, and thus directly programs the hardware modules 13, 14. Thus, EEPROM values are written on the hardware side which result in a functional change in the programmable hardware modules 13, 14. This results in a functional change in the hardware modules 13, 14.

Thus, for example the inputs and outputs, the threshold values, the signal values, or other parameters in the hardware modules 13, 14 may be changed, in particular corresponding to the input values in the development environment 1.

It is preferred for the interface architecture 20 of the embedded web server 2 according to FIG. 4 to be designed as a REST API, since this is a particularly simple and operationally secure data environment.

Consequently, the active element is always the embedded browser 4 into which the data are input via a user input 17, and which then, via the embedded web server 2, transforms the data corresponding to the required development environment 1, in order to thus control the Ethernet connection 7 to the field bus master 8 and the configuration module 9 situated at that location, via the controller interface 15.

Thus, this is a field bus-independent configuration of hardware modules that are suitable for controlling machines and facilities. Accordingly, the programming takes place via a standard web browser 4 that is integrated into the development environment 1.

It is preferred for the web browser 4 to be embedded in a Java environment, which ensures particularly simple operability.

In the final layout, a standard web browser 4 would then be present on a customer-side terminal (a tablet or mobile telephone, for example), which is easily configured using the provider-side development environment 1 according to the invention.

This results in a competitive advantage over known approaches, which do not use a standard browser on the customer-side terminals; instead, a complicated development environment must be provided for the customer side.

Reprogramming and changing the configuration of customer-side hardware modules is therefore particularly simple.

### LIST OF REFERENCE NUMERALS

1 development environment
2 embedded web server
3 interface
4 embedded browser
5 data traffic
6 configuration
7 Ethernet connection
8 field bus master
9 configuration module
10 field bus
11 hardware station
12 station head
13 hardware modules
14 hardware modules
15 interface
16 user interface
17 user input
18 graphical message
19 information arrow
20 interface architecture (REST)
21 data path
22 bus
23 signal path
24 programming sequence

1. A method for operating and controlling a machine installation by means of a graphical development environment (1), with which a controller on the machine side having programmable hardware modules (13, 14) situated there is graphically displayed, and via user-side inputs a programming sequence (24) is created in the development environment (1) and is supplied to the hardware modules (13, 14), characterized in that an embedded web server (2) and an embedded browser (4) that communicates with same are integrated into the development environment (1), and the programming sequence (24) created in the development environment (1) is supplied to a field bus master (8), which supplies the programming sequence (24) via a field bus (10) to the station head (12) of a hardware station (11) in which the hardware modules (13, 14) which are programmable with the programming sequence (24) are situated and communicate with the station head (12).

2. The method according to claim 1, characterized in that the development environment (1) is made up of Eclipse configurator components into which the web server (2) and the browser (4) are integrated.

3. The method according to claim 1, characterized in that the development environment (1) is made up of native Eclipse components in the Java and XTend programming languages.

4. The method according to claim 1, characterized in that at least the following Eclipse functionalities are preferably, but not exclusively, present in the development environment (1):
Change recognition (dirty state editor action): When changes are made in the configurator via the browser, the editor should report this as a flagged change.
Undo/redo action: Changes made in the browser are restored or repeated via the Eclipse undo/redo stack.
Drag&Drop support: The content of the configurator (2, 4) that is integrated into the development environment (1) is transferred to an interface architecture (20) by D&D.
Life cycle of UI components: When a new module (13, 14) is created, the editor should be automatically opened, and the web application for the configuration should be started.
Incorporation of native SC widgets into web configurators.

5. The method according to claim 4, characterized in that the interface architecture (20) is designed as a REST API.

6. The method according to claim 1, characterized in that the Eclipse SWT Browser widget is used as the embedded browser (4) and is integrated into an editor on the development environment side, and the data exchange between the browser and the web server takes place via JSON.

7. The method according to claim 1, characterized in that
1. the application of a new hardware module (13, 14) takes place in the development environment (1),
2. the hardware module (13, 14) from the development environment (1) is opened and the web server (2) is started,
3. the SWT Browser widget (embedded browser 4) is opened, and programs the configurator (6) via a module-specific URL, and
4. the configuration data are written into the configuration module (9) in the field bus master (8) as a hardware-side programming sequence by the web server (2).

8. A device for operating and controlling a machine installation by means of a graphical development environment (1), with which a controller on the machine side having programmable hardware modules (13, 14) situated there is graphically displayed, and via user-side inputs a programming sequence (24) is created in the development environment (1) and is suppliable to the hardware modules (13, 14), characterized in that an embedded web server (2) and an embedded browser (4) that communicates with same are integrated into the development environment (1), and the programming sequence (24) created in the development environment (1) is suppliable to a field bus master (8), which supplies the programming sequence (24) via a field bus (10) to the station head (12) of a hardware station (11) in which the hardware modules (13, 14) which are programmable with the programming sequence (24) are situated and communicate with the station head (12).

9. The device according to claim 8, characterized in that the interface (3) between the embedded web server (2) and the embedded browser (4) is designed as an HTTP interface.

10. The device according to claim 8, characterized in that in an alternative embodiment, the web server (2) is situated in the area of the customer-side hardware station (11).
